(19) United States
(12) Patent Application Publication
(10) Pub. No.: US 2008/0169237 A1
(43) Pub. Date: Jul. 17, 2008

(54) APPARATUS FOR SEPARATING SOLIDS FROM LIQUIDS

(75) Inventors: Douglas W. Schrader, Edmonton (CA); Clarence Nelson, Drayton Valley (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: THE ELIMINATOR TANK & OILFIELD RENTALS LTD., Drayton Valley (CA)

(21) Appl. No.: 11/960,535

(22) Filed: Dec. 19, 2007

(30) Foreign Application Priority Data
Jan. 12, 2007 (CA) 2575474

(51) Int. Cl. B01D 21/26

(52) U.S. Cl. 210/512.2

(57) ABSTRACT

An apparatus for separating solids from liquids includes at least one tank support and at least four tanks. Each of the tanks has a capacity of less than 6 cubic meters, a cylindrical top portion and a sloped bottom adapted to direct solids by force of gravity to a bottom solids outlet controlled by a valve. Each of the tanks is supported by the at least one support in an elevated providing access to the bottom solids outlets. A series of angular upper transfer passages extend between the cylindrical top portions of each of the tanks to facilitate a swirling action of liquid within each tank and a sequential transfer of liquids from tank to tank. The angular upper transfer passages are oriented to alternate between clockwise swirling and counter clockwise swirling.

### FIELD

The present invention relates to an apparatus that is used for separating solids from liquids, such as solids from drilling fluids so the drilling fluids can be reused.

### BACKGROUND

Canadian Patent 2,219,053 (King et al.) discloses a solids separation system in use in the oil industry. Canadian Patent 2,099,554 (Grant) discloses a solids separation system which was used in the oil industry for a number of years, but has now been discontinued.

### SUMMARY

There is provided an apparatus for separating solids from liquids which includes at least one tank support and at least four tanks. Each of the tanks has a capacity of less than 6 cubic meters, a cylindrical top portion and a sloped bottom adapted to direct solids by force of gravity to a bottom solids outlet controlled by a valve. Each of the tanks is supported by the at least one support in an elevated position, providing access to the bottom solids outlets. A series of angular upper transfer passages extend between the cylindrical top portions of each of the tanks to facilitate a swirling action of liquid within each tank and a sequential transfer of liquids from tank to tank. The angular upper transfer passages are oriented to alternate between clockwise swirling and counter clockwise swirling.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view, partially in section, of an apparatus for separating solids from liquids.

FIG. 2 is an end elevation view, in section, of the apparatus for separating solids from liquids illustrated in FIG. 1.

FIG. 3 is a top plan view, in section, of the apparatus for separating solids from liquids illustrated in FIG. 1.

FIG. 4 is a top plan view of the apparatus for separating solids from liquids illustrated in FIG. 3, showing centrifuge and connecting manifold detail.

### DETAILED DESCRIPTION

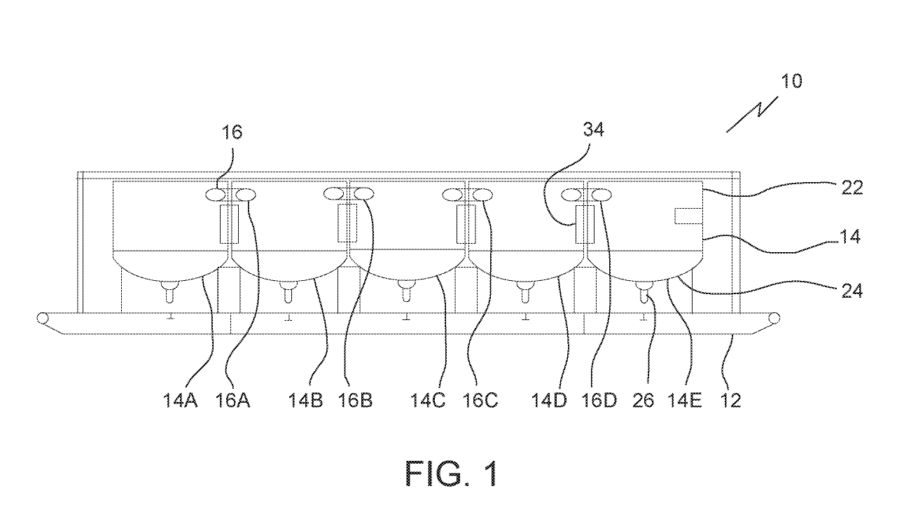

The preferred embodiment, an apparatus for separating solids from liquids generally identified by reference numeral 10, will now be described with reference to FIGS. 1 through 4.

Structure and Relationship of Parts:

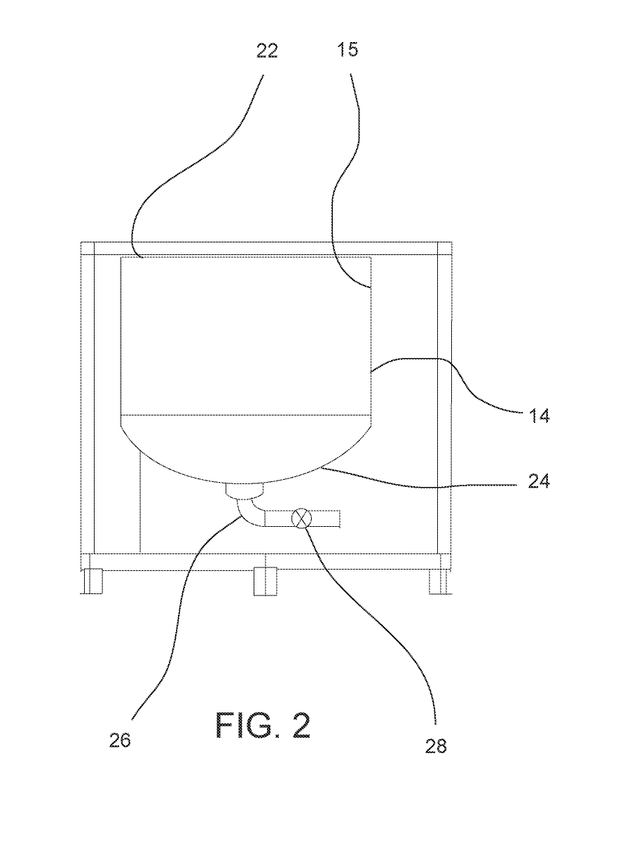

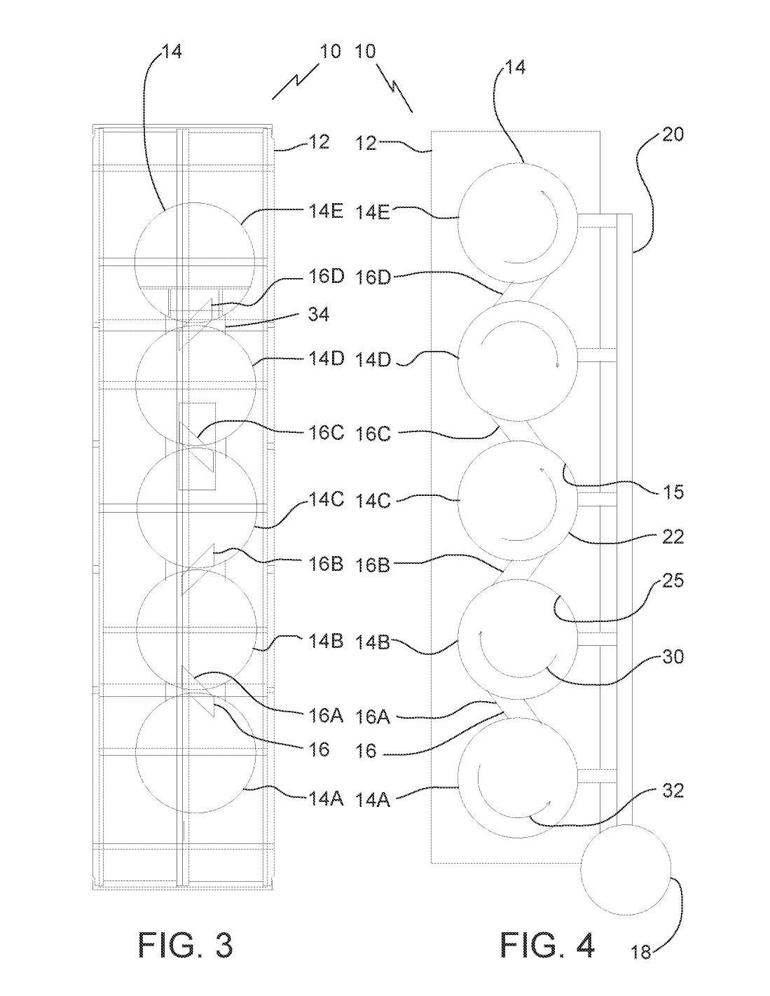

Referring to FIG. 4, apparatus 10 consists of a tank support skid 12, tanks 14, angular upper transfer passages 16, a centrifuge 18, and a manifold 20. The five tanks 14 shown in FIGS. 1, 3 and 4 are labelled 14A, 14B, 14C, 14D and 14E, respectively. The four angular upper transfer passages 16 are labelled 16A, 16B, 16C, and 16D, respectively. Although the embodiment shown in all of FIGS. 1-4 have five tanks 14, it should be understood that the number of tanks 14 should be at least four with a number between four to eight tanks 14 anticipated for most applications. Referring to FIG. 2, tanks 14 have an interior 15, a cylindrical top portion 22, and a sloped bottom 24. Referring to FIG. 4, interior 15 of each of tanks 14 is coated with a non-stick lining 25. Each tank 14 has a capacity of less than 6 cubic meters. In the embodiment shown in all of FIGS. 1-4, tanks 14 have a capacity of 5 cubic meters. Sloped bottom 24 of each tank 14 is adapted to direct solids by force of gravity to a bottom solids outlet 26 controlled by a valve 28, as shown in FIG. 2. Referring to FIGS. 1 and 2, tanks 14 are supported by tank support skid 12 in an elevated position providing access to bottom solids outlets 26. Angular upper transfer passages 16 extend between cylindrical top portions 22 of each of tanks 14 to facilitate a swirling action of liquid within each tank 14 and a sequential transfer of liquids from tank 14 to tank 14, as shown in FIGS. 1, 3 and 4. Referring specifically to FIG. 4, the series of angular upper transfer passages 16 are oriented to alternate between clockwise swirling and counter clockwise swirling. In the embodiment shown in FIG. 4, clockwise arrows 30 and counter clockwise arrows 32 indicate the direction of swirling liquid in each respective tank 14. Tanks 14 are oriented in series, with angular upper transfer passages 16 connecting the series together. Referring to FIGS. 1 and 3, tanks 14 may have support members 34 connecting one tank 14 to tank 14, in order to support tanks 14 and steady them, shown in. Referring to FIG. 4, manifold 20 connects each of tanks 14 to centrifuge 18. Manifold 20 connects to bottom solids outlet 26 (shown in FIG. 2). Referring to FIG. 4, centrifuge 18 is selectively used to draw solids from any of tanks 14 by opening valve 28, valve 28 controlling bottom solids outlet 26 as shown in FIG. 2.

Operation:

In normal operation, liquid (containing solids) is initially transferred to tank 14A, shown in FIG. 4. Tank 14A swirls the liquid in the direction indicated by counter clockwise arrows 32. As tank 14A is swirling liquid, solids may deposit in sloped bottom 24 (shown in FIG. 2). Referring to FIG. 4, the swirling of the liquid causes it to flow through angular upper transfer passage 16A, where the liquid is transferred into tank 14B. Tank 14B swirls liquid in a clockwise direction, as evidenced by clockwise arrows 30. As more and more liquid is transferred into tank 14B, the level of swirling liquid in tank 14B eventually reaches angular upper transfer passage 16B, where it is transferred into tank 14C. The orientation of angular upper transfer passage 16A is such that swirling liquid from tank 14B cannot re-enter tank 14A, as the swirling liquid from tank 14B is preferentially transferred into tank 14C through angular upper transfer passage 16B. The orientation of each angular upper transfer passage 16 is such that only one direction of swirling liquid, either clockwise or counter clockwise, will transfer liquid into the next tank 14. As each successive tank 14 alternates swirling directions, demonstrated by clockwise arrows 30 and counter clockwise arrows 32, there is a net flow of liquid from tanks 14A to tank 14E. In addition, any backflow of liquid between tanks 14 is prevented.

Each successive tank 14 fills up with liquid, and then transfers swirling liquid into the next tank 14. Eventually, the processed liquid is removed from the last tank in the series which, in the embodiment shown, is tank 14E. Referring to FIG. 2, in each tank 14, solids present in the liquids are deposited in sloped bottom 24. Because the process of swirling liquid in each tank 14, allowing solids to deposit, and transferring liquid to the next tank 14 in the series is repeated numerous times, a high degree of solids can be removed from the liquid. As enough liquid is passed through each tank 14, solids can build up in sloped bottom 24, where they are transferred to bottom solids outlet 26. When a pre-determined amount of the solids have built up in tank 14, valve 28 can be opened, allowing the solids to pass into manifold 20. Referring to FIG. 4, the solids are drawn into manifold 20 and into centrifuge 18 by the suction provided by centrifuge 18. Normally, in order to use the maximum amount of suction from centrifuge 18, only one valve 28 from any of tanks 14 is open at a time. Centrifuge 18 should be capable of drawing one cubic meter of solids per minute through manifold 20. At this rate, one of tanks 14 could be entirely emptied in five minutes. Alternatively though, more than one tank 14 may have its respective valve 28 open, in order to clear solids from numerous tanks when required. This provides a method for removing solids from tanks 14, and preventing any large build ups of solids that may plug bottom solids outlet 26. Normally, the bulk of the solids present in the liquid being passed through tanks 14 will be deposited in tanks 14A-C. In the case where a build up of solids does occur in any of tanks 14, water hose may be used to shoot high pressure liquid towards bottom solids outlet 26, in order to unplug a build up of solids. The coating of interiors 15 of tanks 14 with non-stick lining 25 makes cleaning interiors 15 easy.

Tanks 14 of apparatus 10 may be provided with insulating covers (not shown) and heat traces (not shown). The purpose of both insulating covers and heat traces is to protect the components of apparatus 10, as well as the liquid passing through apparatus 10, from environmental conditions. Such protection is required in the very cold environments typically seen at an oilfield site.

Advantages:
1. The basic separator unit consists of a series of between four and eight tanks with angular transfer passages to facilitate swirling liquid transfer between tanks. Beneficial results have been obtained using five tanks. The technology is simple and has no moving parts which can fail. This is to be contrasted with systems that rely heavily upon augers and mechanical agitators.
2. The use of small tanks, each having a capacity of less than 6 cubic meters, reduces the use of water. Beneficial results have been obtained using tanks with a capacity of 5 cubic meters. This is to be contrasted with systems having large capacity tanks where volumes of water must be hauled in to mix with the drilling fluids and the hauled away for disposal after processing of the drilling fluids is completed.
3. When each tank is equipped with a non-stick lining, the tanks can be cleaned on site using water hoses. This is to be contrasted with most systems, which must be cleaned off site by professional waste processors. This is also to be contrasted with tanks where personnel must don safety breathing apparatus to clean inside the tanks.
4. The use of skid mounted small tanks, makes the entire separator unit relatively light weight and easy to transport. This is to be contrasted with other systems using a single huge tank that holds 63 cubic meters of liquids.
5. All parts, such as valves, are easy to access. This is to be contrasted with some systems that have elaborate internal mechanism.
6. The addition of the centrifuge and connecting manifold makes the system particularly efficient. A centrifuge can draw between 0.8 and 1 cubic meters per minute, depending upon the solids content. This means that the contents of each 5 cubic meter tank can be processed through the centrifuge in a little over 5 minutes. By alternating between the tanks with the centrifuge, any significant build up of solids can be completely avoided.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiments without departing from scope of the Claims.

What is claimed is:

1. An apparatus for separating solids from drilling fluids, comprising:
at least one tank support;
at least four tanks, each of the tanks having a capacity of less than 6 cubic meters, a cylindrical top portion and a sloped bottom adapted to direct solids by force of gravity to a bottom solids outlet controlled by a valve, each of the tanks being supported by the at least one support in an elevated providing access to the bottom solids outlets; and
a series of angular upper transfer passages extending between the cylindrical top portions of each of the tanks to facilitate a swirling action of liquid within each tank and a sequential transfer of liquids from tank to tank, the angular upper transfer passages being oriented to alternate between clockwise swirling and counter clockwise swirling.

2. The apparatus of claim 1, wherein there is a single tank support.

3. The apparatus of claim 2, wherein the tank support is a skid.

4. The apparatus of claim 1, wherein each of the tanks has a non-stick lining.

5. The apparatus of claim 1, wherein a centrifuge is provided and a manifold connects each of the tanks to the centrifuge, with the centrifuge selectively being used to draw solids from any of the tanks by opening the valve that controls the bottom outlet.

6. An apparatus for separating solids from drilling fluids, comprising:
a tank support skid;
at least four tanks, each of the tanks having a capacity of less than 6 cubic meters, a cylindrical top portion and a sloped bottom adapted to direct solids by force of gravity to a bottom solids outlet controlled by a valve, each of the tanks being supported by the support skid in an elevated providing access to the bottom solids outlets;
a series of angular upper transfer passages extending between the cylindrical top portions of each of the tanks to facilitate a swirling action of liquid within each tank and a sequential transfer of liquids from tank to tank, the angular upper transfer passages being oriented to alternate between clockwise swirling and counter clockwise swirling;
a centrifuge; and
a manifold connecting each of the tanks to the centrifuge, with the centrifuge selectively used to draw solids from any of the tanks by opening the valve that controls the bottom outlet.

7. The apparatus of claim 6, wherein each of the tanks has a non-stick lining.
